(19) United States
(12) Patent Application Publication
(10) Pub. No.: US 2026/0368323 A1
(43) Pub. Date: Nov. 19, 2026

(54) LOCKER PROTECTION WITH HIDDEN BOOT FILES

(71) Applicant: Arms Cyber Defense, Inc., Brentwood, TN (US)

(72) Inventors: Timothy Ryan Potteiger, Pasadena, MD (US); Bradley David Potteiger, Baltimore, MD (US); Robert T. Kruse, Los Gatos, CA (US)

(73) Assignee: Arms Cyber Defense, Inc., Brentwood, TN (US)

(21) Appl. No.: 19/565,647

(22) Filed: Mar. 13, 2026

Related U.S. Application Data
(63) Continuation-in-part of application No. 19/529,329, filed on Feb. 4, 2026.
Application No. 19/529,329 is a continuation-in-part of application No. 19/454,559, filed on Jan. 21, 2026.
Application No. 19/454,559 is a continuation-in-part of application No. 19/426,359, filed on Dec. 19, 2025.
Application No. 19/426,359 is a continuation-in-part of application No. 18/926,125, filed on Oct. 24, 2024.
Application No. 18/926,125 is a continuation-in-part of application No. 18/926,262, filed on Oct. 24, 2024.
(60) Provisional application No. 63/737,820, filed on Dec. 23, 2024.
(60) Provisional application No. 63/747,948, filed on Jan. 22, 2025.
(60) Provisional application No. 63/753,998, filed on Feb. 5, 2025.
(60) Provisional application No. 63/771,722, filed on Mar. 14, 2025.
(60) Provisional application No. 63/794,474, filed on Apr. 25, 2025.
(60) Provisional application No. 63/795,543, filed on Apr. 27, 2025.
(60) Provisional application No. 63/870,913, filed on Aug. 27, 2025.
(60) Provisional application No. 63/888,551, filed on Sep. 26, 2025.
(60) Provisional application No. 63/888,563, filed on Sep. 26, 2025.
(60) Provisional application No. 63/896,769, filed on Oct. 10, 2025.
(60) Provisional application No. 63/900,128, filed on Oct. 16, 2025.
(60) Provisional application No. 63/906,161, filed on Oct. 27, 2025.
(60) Provisional application No. 63/909,446, filed on Oct. 31, 2025.
(60) Provisional application No. 63/909,487, filed on Oct. 31, 2025.
(60) Provisional application No. 63/926,869, filed on Nov. 28, 2025.
(60) Provisional application No. 63/952,004, filed on Dec. 31, 2025.
(60) Provisional application No. 63/978,290, filed on Feb. 9, 2026.
(60) Provisional application No. 64/000,356, filed on Mar. 9, 2026.

(51) Int. Cl. G06F 21/56; G06F 21/54; G06F 21/57

(52) U.S. Cl. CPC G06F 21/568; G06F 21/54; G06F 21/575

(57) ABSTRACT

An agent running on a client device saves one or more client boot records based on a hidden location. During a shutdown operation on the client device, the agent compares one or more boot records with the one or more boot records that were saved. A supervisor process searches one or more exclusion lists to allow or deny access to the one or more client boot records on the client device. Prior to the completion of the shutdown operation, the agent restores the one or more client boot records that were saved, based on the comparing of the client boot records. The agent reports to a user the restoring of the boot records. The agent communicates to a system administrator the restoring of the boot records. An I/O filter driver intercepts a request to access the hidden location by a process on the client device.

### RELATED APPLICATIONS

This application claims the benefit of U.S. provisional patent applications “Locker Protection With Hidden Boot Files” Ser. No. 63/771,722, filed Mar. 14, 2025, “Process-Specific Ghosting Of Digital Assets” Ser. No. 63/795,543, filed Apr. 27, 2025, “Process-Based Authentication Of New Processes” Ser. No. 63/794,474, filed Apr. 25, 2025, “Address-Specific Ghosting Of Networked Devices” Ser. No. 63/870,913, filed Aug. 27, 2025, “Partial Trust Security With A Ghosted File Archive” Ser. No. 63/888,551, filed Sep. 26, 2025,“Returning Obfuscated Data In Response To A Malicious Process” Ser. No. 63/896,769, filed Oct. 10, 2025, “Call Function Address Obfuscation With ROP Checks” Ser. No. 63/888,563, filed Sep. 26, 2025, “Reducing False Security Alarms With Decoy Files In A Macintosh™ Environment” Ser. No. 63/900,128, filed Oct. 16, 2025, “Endpoint Protection With User-Defined Hidden Assets In A Macintosh Environment” Ser. No. 63/906,161, filed Oct. 27, 2025, “Returning Obfuscated Data In Response To A Malicious Process In A Macintosh Environment” Ser. No. 63/909,446, filed Oct. 31, 2025, “Forensic Logging Of Accessed Ghosted Digital Assets” Ser. No. 63/909,487, filed Oct. 31, 2025, “Building Endpoint Intelligence With A Cognitive Learning Architecture” Ser. No. 63/926,869, filed Nov. 28, 2025, “Cybersecurity Search Vector Optimization In A Distributed Deep Learning Network” Ser. No. 63/952,004, filed Dec. 31, 2025, “Endpoint Security With A Dual Architecture Learning Memory System” Ser. No. 63/966,366, filed Jan. 23, 2026, “Controlling Access To Ghosted Files With A Full Pathname” Ser. No. 63/979,290, filed Feb. 10, 2026, and “Preventing Corruption Of A Unified Extensible Firmware Interface Partition On A Client Device” Ser. No. 64/000,356, filed Mar. 9, 2026.

This application is also a continuation-in-part of U.S. patent application “Endpoint Protection With User-Defined Hidden Assets” Ser. No. 19/529,329, filed Feb. 4, 2026, which claims the benefit of U.S. provisional patent applications “Endpoint Protection With User-Defined Hidden Assets” Ser. No. 63/753,998, filed Feb. 5, 2025, “Locker Protection With Hidden Boot Files” Ser. No. 63/771,722, filed Mar. 14, 2025, “Process-Specific Ghosting Of Digital Assets” Ser. No. 63/795,543, filed Apr. 27, 2025, “Process-Based Authentication Of New Processes” Ser. No. 63/794,474, filed Apr. 25, 2025, “Address-Specific Ghosting Of Networked Devices” Ser. No. 63/870,913, filed Aug. 27, 2025, “Partial Trust Security With A Ghosted File Archive” Ser. No. 63/888,551, filed Sep. 26, 2025, “Returning Obfuscated Data In Response To A Malicious Process” Ser. No. 63/896,769, filed Oct. 10, 2025, “Call Function Address Obfuscation With ROP Checks” Ser. No. 63/888,563, filed Sep. 26, 2025, “Reducing False Security Alarms With Decoy Files In A Macintosh™ Environment” Ser. No. 63/900,128, filed Oct. 16, 2025, “Endpoint Protection With User-Defined Hidden Assets In A Macintosh Environment” Ser. No. 63/906,161, filed Oct. 27, 2025, “Returning Obfuscated Data In Response To A Malicious Process In A Macintosh Environment” Ser. No. 63/909,446, filed Oct. 31, 2025, “Forensic Logging Of Accessed Ghosted Digital Assets” Ser. No. 63/909,487, filed Oct. 31, 2025, “Building Endpoint Intelligence With A Cognitive Learning Architecture” Ser. No. 63/926,869, filed Nov. 28, 2025, “Cybersecurity Search Vector Optimization In A Distributed Deep Learning Network” Ser. No. 63/952,004, filed Dec. 31, 2025, and “Endpoint Security With A Dual Architecture Learning Memory System” Ser. No. 63/966,366, filed Jan. 23, 2026.

The U.S. patent application “Endpoint Protection With User-Defined Hidden Assets” Ser. No. 19/529,329, filed Feb. 4, 2026 is also a continuation-in-part of U.S. patent application “Exfiltration Protection With Command Line Filtering” Ser. No. 19/454,559, filed Jan. 21, 2026, which claims the benefit of U.S. provisional patent applications “Exfiltration Protection With Command Line Filtering” Ser. No. 63/747,948, filed Jan. 22, 2025, “Endpoint Protection With User-Defined Hidden Assets” Ser. No. 63/753,998, filed Feb. 5, 2025, “Locker Protection With Hidden Boot Files” Ser. No. 63/771,722, filed Mar. 14, 2025, “Process-Specific Ghosting Of Digital Assets” Ser. No. 63/795,543, filed Apr. 27, 2025, “Process-Based Authentication Of New Processes” Ser. No. 63/794,474, filed Apr. 25, 2025, “Address-Specific Ghosting Of Networked Devices” Ser. No. 63/870,913, filed Aug. 27, 2025, “Partial Trust Security With A Ghosted File Archive” Ser. No. 63/888,551, filed Sep. 26, 2025, “Returning Obfuscated Data In Response To A Malicious Process” Ser. No. 63/896,769, filed Oct. 10, 2025, “Call Function Address Obfuscation With ROP Checks” Ser. No. 63/888,563, filed Sep. 26, 2025, “Reducing False Security Alarms With Decoy Files In A Macintosh™ Environment” Ser. No. 63/900,128, filed Oct. 16, 2025, “Endpoint Protection With User-Defined Hidden Assets In A Macintosh Environment” Ser. No. 63/906,161, filed Oct. 27, 2025, “Returning Obfuscated Data In Response To A Malicious Process In A Macintosh Environment” Ser. No. 63/909,446, filed Oct. 31, 2025, “Forensic Logging Of Accessed Ghosted Digital Assets” Ser. No. 63/909,487, filed Oct. 31, 2025, “Building Endpoint Intelligence With A Cognitive Learning Architecture” Ser. No. 63/926,869, filed Nov. 28, 2025, and “Cybersecurity Search Vector Optimization In A Distributed Deep Learning Network” Ser. No. 63/952,004, filed Dec. 31, 2025.

The U.S. patent application “Exfiltration Protection With Command Line Filtering” Ser. No. 19/454,559, filed Jan. 21, 2026, is also a continuation-in-part of U.S. patent application “Reducing False Security Alarms With Decoy Files” Ser. No. 19/426,359, filed Dec. 19, 2025, which claims the benefit of U.S. provisional patent applications “Reducing False Security Alarms With Decoy Files” Ser. No. 63/737,820, filed Dec. 23, 2024, “Exfiltration Protection With Command Line Filtering” Ser. No. 63/747,948, filed Jan. 22, 2025, “Endpoint Protection With User-Defined Hidden Assets” Ser. No. 63/753,998, filed Feb. 5, 2025, “Locker Protection With Hidden Boot Files” Ser. No. 63/771,722, filed Mar. 14, 2025, “Process-Specific Ghosting Of Digital Assets” Ser. No. 63/795,543, filed Apr. 27, 2025, “Process-Based Authentication Of New Processes” Ser. No. 63/794,474, filed Apr. 25, 2025, “Address-Specific Ghosting Of Networked Devices” Ser. No. 63/870,913, filed Aug. 27, 2025, “Partial Trust Security With A Ghosted File Archive” Ser. No. 63/888,551, filed Sep. 26, 2025, “Returning Obfuscated Data In Response To A Malicious Process” Ser. No. 63/896,769, filed Oct. 10, 2025, “Call Function Address Obfuscation With ROP Checks” Ser. No. 63/888,563, filed Sep. 26, 2025, “Reducing False Security Alarms With Decoy Files In A Macintosh™ Environment” Ser. No. 63/900,128, filed Oct. 16, 2025, “Endpoint Protection With User-Defined Hidden Assets In A Macintosh Environment” Ser. No. 63/906,161, filed Oct. 27, 2025, “Returning Obfuscated Data In Response To A Malicious Process In A Macintosh Environment” Ser. No. 63/909,446, filed Oct. 31, 2025, and “Forensic Logging Of Accessed Ghosted Digital Assets” Ser. No. 63/909,487, filed Oct. 31, 2025.

The U.S. patent application “Reducing False Security Alarms With Decoy Files” Ser. No. 19/426,359, filed Dec. 19, 2025, is also a continuation-in-part of U.S. patent application “Malicious Software Mitigation” Ser. No. 18/926,262, filed Oct. 24, 2024.

The U.S. patent application “Reducing False Security Alarms With Decoy Files” Ser. No. 19/426,359, filed Dec. 19, 2025, is also a continuation-in-part of U.S. patent application “Recovery From Malicious Software” Ser. No. 18/926,125, filed Oct. 24, 2024.

Each of the foregoing applications is hereby incorporated by reference in its entirety.

### FIELD OF ART

This application relates generally to data analysis and more particularly to locker protection with hidden boot files.

### BACKGROUND

Squatting has long been a form of occupying unused or abandoned land and claiming it for one's own. Ancient Rome even had a name for the practice: adversus possessores or adverse possession. Common law in many countries allows for the acquisition of property, usually real property, on the basis of continuous possession or occupation. During the westward expansion in the United States, settlers occupied land without legal title. This was particularly true on lands held by Native American tribes or lands that were part of the public domain. Land ownership was a means of gaining economic opportunity. Over time, political pressures led to granting titles and land deeds to allow squatters to purchase the land that they occupied. During the Great Depression, squatting became more prevalent as people sought shelter in abandoned or vacant properties. This trend occurred in Europe as well as the U.S. After World War II, many refugees found shelter wherever they could, often in homes and other properties left vacant by those killed in the war.

Home title theft is a type of real estate fraud in which a bad actor uses a property owner's information to forge a deed and steal a home. The fraud begins by stealing personal information about the homeowner. This can be done through phishing swindles, malware that fools an owner into providing personal details, data breaches, mail theft, and so on. The thief can use the homeowner's personal information to forge a deed and register it with local municipalities. Property thieves most often target unoccupied homes, secondary residences, vacation homes, rentals, and so on. The thief may apply for a home equity loan or line of credit in the homeowner's name and then fail to make payments, exposing the owner to credit damage and foreclosure. In some cases, the thief may sell an unoccupied home without the owner's knowledge or rent the property without permission. Squatters can also steal homes by occupying them while the owner is away and then refusing to leave.

The rights assigned to squatters vary greatly from country to country, and in some cases from state to state. In general, a property owner can recover possession of property from unauthorized possessors through legal action. But time can become a factor in such proceedings. In the United States, statutes of limitation set a time limit for property owners to exercise their right to reclaim property. Different states have different time limits, from as little as three years to as many as forty years. The owner must be able to prove ownership, through land deeds, title, or other documentation. Courts of law which oversee real property issues can be slow to respond, sometimes requiring years to complete eviction actions or confirm ownership.

Property theft is not limited to real estate. Boats and yachts, cars and trucks, jewelry, paintings, sculptures, and so on; nearly anything of value can and has been stolen by others impersonating or stealing personal information in order to falsely claim ownership. In many cases, possession can be nine-tenths of the law, meaning that ownership is easier to maintain when one has possession of an item. This can be true with digital properties as well. From identities to confidential data, theft of digital property is as prevalent as the theft of physical possessions. And gaining ownership back from thieves, once a bad actor has taken possession, can be just as difficult and expensive as getting back one's stolen home or car.

### SUMMARY

Cyberattacks come in many forms: viruses, trojans, denial-of-service (DoS), phishing, spoofing, and so on. One of the most effective is also one of the simplest to understand: password additions or changes. Today's computing systems implement passwords at many different levels—within applications, hardware and firmware, operating systems, and so on. Password attacks use these options against the user, by setting or changing passwords to lock others out of a program or system. The attacker then holds the new password for ransom, attempting to force the user to pay for the password or face rebuilding an application or entire system. Worse, the attacker may never reveal the password, instead aiming to cause destruction or loss of data. Bad actors often focus password attacks on the boot records used to start the operating system on a compute device. Adding or changing a password at the boot record level can effectively lock a user out from accessing any programs or data stored on the device. Changing the password within a boot record is not the only sort of attack that can be made to such files. Boot records can be erased, renamed, copied, moved to a different location on a storage device, and so on. These changes can render a compute device inoperable, requiring system administrator level access to repair or rebuild the operating system. Such attacks can be expensive, not only in terms of ransoms paid for passwords, but also from lost time, data, and productivity. Protecting boot records is thus a critical component in protecting compute devices from malicious attacks. A layered approach to boot record protection is key in keeping these critical files safe and functional.

Techniques for locker protection with hidden boot files are disclosed. An agent running on a client device saves one or more client boot records based on a hidden location. During a shutdown operation on the client device, the agent compares one or more boot records with the one or more boot records that were saved. A supervisor process searches one or more exclusion lists to allow or deny access to the one or more client boot records on the client device. Prior to the completion of the shutdown operation, the agent restores the one or more client boot records that were saved, based on the comparing of the client boot records. The agent reports to a user the restoring of the boot records. The agent communicates, to a system administrator, the restoring of the boot records.

A processor-implemented method for data analysis is disclosed comprising: saving, by an agent running on a client device, one or more client boot records associated with the client device, wherein the saving is based on a hidden location; comparing, during a shutdown operation on the client device, the one or more client boot records with the one or more client boot records that were saved; and restoring, by the agent, prior to conclusion of the shutdown operation, the one or more client boot records that were saved, wherein the restoring is based on the comparing. Some embodiments comprise intercepting, by an input/output (I/O) filter driver, a request by a process on the client device to access the hidden location. Some embodiments comprise searching for the process within one or more exclusion lists. In embodiments, the searching is based on a supervisor process running in user space on the client device. In embodiments, the one or more exclusion lists comprise one or more hardcoded process names. Some embodiments comprise allowing the request, wherein the process was found within the one or more exclusion lists. Some embodiments comprise updating, by the process, the one or more client boot records that were saved.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for locker protection with hidden boot files.

FIG. 2 is a flow diagram for overriding locker protection for legitimate updating processes.

FIG. 3 is an infographic for a locker attack.

FIG. 4 is an infographic for locker protection with hidden boot files.

FIG. 5 is an infographic for nullifying boot record lineage detection.

FIG. 6 is an infographic for locker protection with hidden boot records.

FIG. 7 is a table showing common cyberthreats.

FIG. 8 is a diagram showing cyberthreat countermeasures.

FIG. 9 is a system diagram for locker protection with hidden boot files.

### DETAILED DESCRIPTION

Cyber crime takes many forms. Cyber theft, which includes taking possession of digital or physical computing assets for ransom, stealing data, or malicious disruption or destruction, is a form of crime that can be particularly difficult to address. Computer locking—using malware to add or change passwords on a computer system—can be accomplished in order to hold a system for ransom, steal data from computer systems, disrupt usage, or destroy access to operating systems. Locking can cost users and businesses time, money, and productivity. In one example, malicious software can edit a master boot record, volume boot record, etc. of a client device. The malicious software can insert a password not known to the user into one or more of the above boot records. This can have no effect on a system when running, thus the password insertion can be transparent to the user. However, when the client device is restarted, the insertion of the password can prevent the machine from booting. Without the password, the user is unable to access the device. Schemes such as these can cost businesses significant time and effort. To combat these types of malicious attacks, techniques for locker protection with hidden boot files are disclosed.

A software agent can be added to a client device. The agent can save one or more client boot records associated with the client device. The boot records can include a master boot record (MBR), a volume boot record (VBR), a GUID partition table, and so on. The saving is based on a hidden location. The hidden location can reside on the client device or can be external to the client device. During a shutdown operation on the client device, the one or more boot records are compared with the one or more boot records that were saved. Prior to the conclusion of the shutdown operation, the one or more client boot records that were saved are restored. The restoring is based on the comparing. An I/O filter driver can intercept a request by a process on the client device to access the hidden location. A supervisor process running in user space on the client device can search for the process within one or more exclusion lists, which can include hardcoded process names. The request can be denied when the process was not found within the one or more exclusion lists. The request can be allowed when the process was found within the one or more exclusion lists, and the process can update the one or more client boot records that were saved. Similarly, the I/O filter driver can intercept a request by a process on the client device to access the boot records. As before, the supervisor process can look for the process within one or more exclusion lists. The restoring can be overridden when the process was found within the one or more exclusion lists.

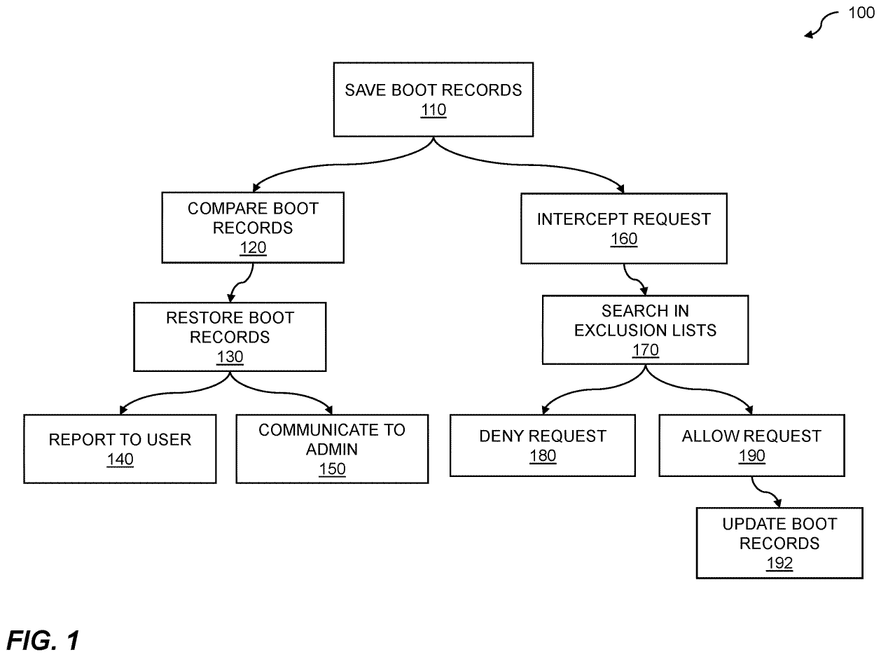

FIG. 1 is a flow diagram for locker protection with hidden boot records. The flow 100 includes saving, by an agent running on a client device, one or more client boot records 110 associated with the client device. The client device can be a personal computer, laptop, desktop, pad, tablet, workstation, smartphone, and so on. The client device can be running an operating system including Microsoft Windows®, macOS®, Linux®, Android®, iOS®, Chrome OS®, and so on. The agent can be a computer program which acts autonomously on behalf of a user or another program. It can perform tasks, make decisions, and interact with other agents or systems to achieve specific goals. The agent can be a reflex agent, responding directly to operating system conditions based on a set of predefined rules. The agent can be a model-based reflex agent, using one or more machine learning models to make decisions and perform tasks. The agent can be utility-based, selecting actions in order to maximize overall utility and stability, and so on. The agent can be installed as a desktop application, including a user interface and execution environment within system or user memory space. The agent can run as a service on the client device, starting automatically when the client device operating system is booted. The agent can be installed, managed, etc. by a system administrator. The agent can run within a virtual machine running on the client device, can be integrated with a larger security application, can be a plug-in addition to existing security applications installed on the client device, etc.

In embodiments, the one or more client boot records include a master boot record (MBR). An MBR can be contained in the first sector of a hard drive or removable drive. It can function as the instruction manual for a client device, telling the system how the drive is organized and where to find the operating system. It can contain a bootloader program that starts the loading of the operating system and a partition table, which is a map of the drive to show how it is divided into sections or partitions. In embodiments, the one or more client boot records include a volume boot record (VBR). Similar to an MBR, a VBR can reside on the first sector of a hard drive or solid state drive (SSD) partition. A hard drive or SSD can be divided into multiple partitions, each with its own VBR. The VBR can also contain a bootloader program and information about the file system used within the partition. The VBR can be used to continue a sequence of starting an operating system, after the MBR has identified which drive partition to boot from. In embodiments, the one or more client boot records include a GUID partition table. Modern compute devices can include a globally unique identifier (GUID) to identify drive partitions and types. Each GUID can function as a unique serial number, ensuring that each drive partition has a distinct ID. A GUID partition table (GPT) can contain a layout of the one or more partitions on a storage device, such as a hard drive or SSD. The GPT can be used on larger drives than the older MBR, manage more partitions per drive, and include additional security features.

The saving is based on a hidden location. The agent can identify a hidden storage location on one or more drive partitions included in the storage device, on a connected server such as a cloud server, on a secondary device such as a universal serial bus (USB) flash drive, and so on. The hidden storage location can be an unused area in one partition of a storage device, can be divided across one or more unused or empty sections of a storage device partition, can be divided across one or more storage device partitions, and so on. The one or more hidden storage locations can be reserved by the software agent so that data written to or read by other processes do not include the hidden storage location drive sections. The agent can record one or more copies of the client boot records to the hidden storage location. The one or more copies of the client boot records can include date, time stamps, user information, device information, process information, and so on for identification.

The flow 100 includes comparing, during a shutdown operation on the client device, the one or more client boot records 120 with the one or more client boot records that were saved. The comparing can be accomplished by an operating system command such as the diff command in Linux or the fc command in Windows; by a hex editor like Bless in Linux or HxD in Windows; by a disk imaging, backup, or recovery software application; etc. The comparing can include filenames, timestamps, file sizes, and so on. The comparing can include file hash information. A file hash can be a fixed-size string of alphanumeric characters applied to the contents of a file, such as a client boot record. The string is unique to the specific file. Even a tiny change in the file, such as a single character in one word or command, will result in a completely different file hash string. Changes made to a file do not correspond to resulting changes in the associated file hash. Thus, a file hash cannot be used to decode the contents of a hashed file.

The flow 100 includes restoring, by the agent, prior to the conclusion of the shutdown operation, the one or more client boot records 130 that were saved. As described above, the boot records can be compared. When a difference is detected, the agent can assume that the change was due to malicious code. The restoring is based on the comparing. The restoring can be completed when the one or more active client boot records do not match the one or more copies of the client boot records saved in the hidden storage areas by the agent. The restoring can include deleting the current boot records and replacing them with copies of the boot record stored in the hidden storage area. The restoring can be accomplished by an operating system copy command such as cp or scp in Linux, copy or xcopy in Windows, and so on. The restoring can be accomplished by a boot record utility such as bootrec.exe in Windows, grub or LILO in Linux, and so on. The restoring can be accomplished by a third-party software application.

The flow 100 includes reporting, by the agent, the restoring to a user 140 of the client device. The agent can report the restoring via an email, message, app, text, and so on. The agent can include a dashboard graphics user interface (GUI). A dashboard GUI can be a visual interface on a client device that displays key metrics, data graphics, and other relevant information in a clear and easily understood way. The agent can use the GUI to notify the user about changes in the one or more client boot records before or after restoring the boot records. The agent can start the GUI to notify the user after the client boot records have been restored from the hidden location. The GUI can allow the user to display additional details related to a boot record restore, including details on the process that changed the one or more client boot records, the date and time of the client boot record changes, and so on. The GUI can allow the user and/or system administrator to make choices about whether to allow the restoring of the client boot records to continue working or rather to stop the restoring process.

The flow 100 includes communicating, by the agent, the restoring to a system administrator 150. The agent can include access to text messaging, email, voice communications, and network-based software applications. The agent can use one or more methods to notify a system administrator about changes in the one or more client boot records before restoring the boot records. The agent can notify the system administrator before or after the client boot records have been restored from the hidden location. The agent can allow the system administrator to display additional details related to an alert, including the client device identification, location, logged in user, details on the process that changed the one or more client boot records, the date and time of the client boot record changes, and so on. The agent can allow the system administrator to make choices about whether to allow the restoring of the client boot records to continue working, or rather to stop the restoring process. The agent can summarize restoring data across any number of client devices for the system administrator.

As described above, one or more boot records can be saved to a hidden location. A process can attempt to access the hidden location. The flow 100 includes intercepting, by an I/O filter driver, a request 160 by a process on the client device to access the hidden location. An I/O filter driver can be a software component that intercepts input and output operations between a program, device driver, etc. and the operating system. It can function as a go-between, allowing for additional operations, filtering, or redirecting of data before it reaches its destination. The I/O filter driver can intercept requests to perform file operations on the hidden location created by the agent, such as reading, copying, deleting, and so on client boot records or other files. There can be legitimate reasons for changes to a client boot record. Updates from manufacturers, operating system vendors, system component vendors, and so on can require updates to client boot records in order to improve performance, increase security, add new features, and so on. Malicious activities on a client device can also include changes to client boot records. Enabling a password or encrypting client boot records can be used to hold a client device for ransom. Deleting or intentionally damaging boot record files can be done to incapacitate storage drives and/or operating systems. More subtle changes can be made to boot records to allow for backdoor access to client devices in order to make later access easier for stealing data, and so on. The I/O filter driver can identify requests to access the hidden location storing client boot record copies as they are generated by legitimate or malicious applications or processes, and can further identify the application or process which generated the request.

The flow 100 includes searching for the process within one or more exclusion lists 170, wherein the searching is based on a supervisor process running in user space on the client device. As requests to access and/or operate on files in the hidden location are generated and detected by the file I/O filter driver, the program or process generating the request can be identified as well. The process name can be used as a search criterion against a list of programs and processes included in the one or more exclusion lists. The exclusion lists can be made up of legitimate processes such as operating system processes, known application processes, network and communications processes, backup processes, virus scan and other malware protection processes, and so on which are included on the client device. The exclusion lists can include file dates, file sizes, hashes, and other information related to legitimate drivers, programs, and processes that can originate file and/or directory requests. The supervisor process running in user memory can compare the details of a process generating the request to access the hidden location to the list of processes included in the exclusion lists. The searching can be based on the intercepting. As one or more I/O filter drivers intercept requests to access client boot records, including copies of boot records in the hidden location, details on the requests can be sent to the supervisor process for analysis.

In embodiments, the one or more exclusion lists comprise one or more hardcoded process names. In a usage example, the process used to copy the client boot records to the hidden location when the client device is booted can be included in the exclusion lists. Legitimate client boot record processes can be programmed to update the most recent version of the client boot record stored in the hidden location, as well as the active client boot record files stored in the boot partition of the client device. Thus, if a malicious attempt to alter or destroy the active client boot record occurs later, a legitimate version of the boot records can be put into place during shutdown. Details about these legitimate processes can be placed in the exclusion lists. In cases where a malicious process alters the active client boot records prior to a legitimate update process of the client boot record, an older version of the client boot records stored in the hidden location can be used to recover access to the client device. For example, if the agent keeps three generations of the client boot records in the hidden location and the most recent version of the boot records is impacted by a malicious process, along with the active boot records, the user or a system administrator can boot the client device from a separate portable device, such as a USB drive, DVD, or CD; access the hidden location; and restore the second or third generation of the client boot record to the client device to defeat the malicious process. In another usage example, the agent can include the name of one or more processes that are allowed access to the hidden location within its code. For example, a Windows update process name can be hardcoded in the agent's code to allow that process access to the hidden file location.

The flow 100 includes denying the request 180, wherein the process was not found within the one or more exclusion lists. In instances where a process is not recorded in the one or more exclusion lists, and/or hardcoded within the agent's code, the agent can kill the process request in the operations queue and notify the user and/or system administrator. The flow 100 includes allowing the request 190, wherein he process was found within the one or more exclusion lists. In instances where a process requests access to the hidden location and the process appears in one or more exclusion lists and/or is hardcoded with the agent, the agent can allow the process to continue. The agent can notify the user and/or system administrator that the process has been operated on the client boot records stored in the hidden location. The flow 100 includes updating, by the process, the one or more client boot records 192 that were saved. Some programs or processes can update the active client boot records directly. The agent and I/O driver can identify legitimate processes that update the active boot records and make copies of the updated boot records to the hidden location when the update process is completed.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

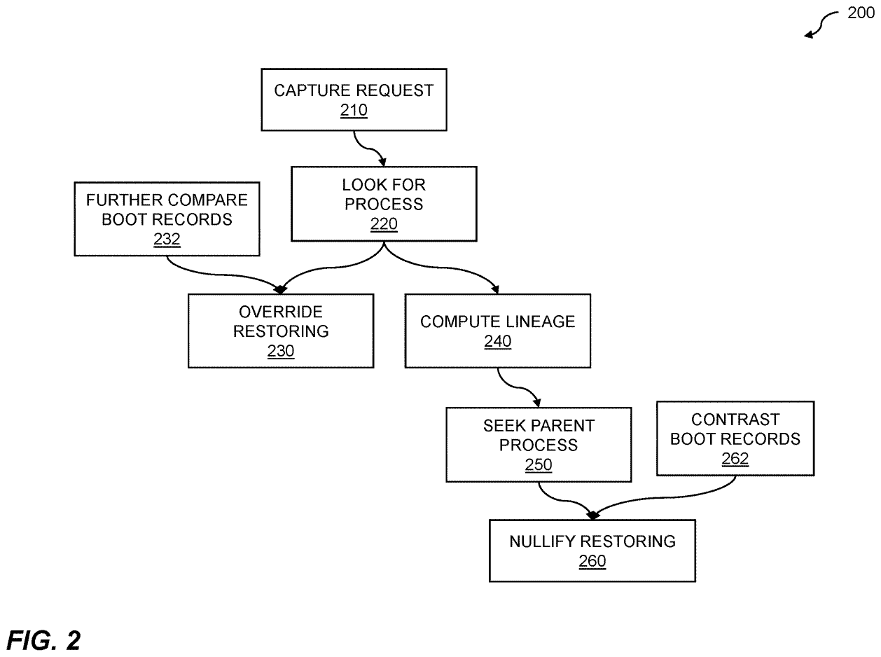

FIG. 2 is a flow diagram for overriding locker protection for legitimate updating processes. The flow 200 includes capturing, by an I/O filter driver, a request 210 by a process on the client device to access the one or more client boot records. As mentioned above and throughout, the I/O filter driver can be a software component that intercepts input and output operations between a program, device driver, etc. and the operating system. It can function as a go-between, allowing for additional operations, filtering, or redirecting of data before it reaches its destination. The I/O filter driver can intercept attempts to perform file operations, such as reading, copying, deleting, and so on, on the client boot records. The file I/O filter driver can identify requests to access the active client boot records as they are generated by legitimate and/or malicious processes, and can further identify the application or process which generated the request.

The flow 200 includes looking for the process 220 within one or more exclusion lists, wherein the looking is based on a supervisor process running in user space on the client device. As requests to access and/or operate on one or more client boot records are detected by the I/O filter driver, the program or process generating the request can be identified. The process name can be used as a look criterion against a list of programs and processes included in the one or more exclusion lists. The exclusion lists can be made up of legitimate processes such as operating system processes, known application processes, network and communications processes, backup processes, updating processes, virus scan and other malware protection processes, and so on which are included on the client device. The exclusion lists can include file dates, file sizes, hashes, and other information related to legitimate drivers, programs, and processes that can originate file and/or directory requests. As one or more I/O filter drivers intercept requests to access client boot records, including copies of boot records in the hidden location, details on the requests can be sent to the supervisor process for analysis. The supervisor process can compare any of the details of a process generating the request to access the client boot records to the list of processes included in the exclusion lists.

The flow 200 includes overriding the restoring 230, wherein the process was found within the one or more exclusion lists. Recall that an agent running on the device can compare boot records on the device to those that were previously stored. The saving can occur during or after a boot sequence. Thus, a known “good” copy of the boot records can be saved to a hidden location on the device, on a USB flash drive, on a server, etc. During a shutdown process, the agent can compare one or more boot records that were saved to the hidden location with one or more boot records on the device. When the records are different, the agent can determine that the change was due to a malicious process and can restore the current boot records on the device with those that were previously saved. However, a legitimate process, such as one listed in one or more exclusion lists, may have updated the boot record. In this case, the agent should not copy the saved boot records, but can allow the edits to remain. In instances where the process changing the active boot record is a legitimate process, the agent can override the restoring of the boot records from the version stored in the hidden location. Even though the active client boot record is different than the copy of the client boot record stored in the hidden location, the agent can disallow the restoring process that can occur during shutdown. In some examples, the agent can notify the user and/or system administrator that the process has performed a change on the active client boot record.

A trusted process can update the boot records at any time after startup. It is possible that an OS update, which can update one or more boot records, can run when a system update is also taking place. In this case, it is possible that both a trusted process and a malicious process updated the boot record. Since the trusted process updated the record, the restoring would be overridden, resulting in a lock being left in the boot file and the user being locked out during the next restart. To prevent this situation, one or more additional comparisons can be performed by the agent prior to allowing the update by the trusted process. In embodiments, the overriding includes further comparing the one or more client boot records 232 with the one or more client boot records that were saved. If the further comparing results in a mismatch between an active boot record and a boot record that was saved, the trusted process can be paused, halted, etc., and the original boot records can be restored. The process can then be unpaused, restarted, etc. The boot records that were updated by the trusted process can then be saved in the hidden location. Before shutdown, the updated boot records can be compared to the active boot records to ensure that no malicious updates, such as an update due to a locker, has occurred.

The flow 200 includes computing, by the supervisor process, a process lineage 240. The computing includes one or more parent processes. Some processes can generate additional processes to complete program tasks. For example, a process to upgrade a client boot record can include processes to make a backup copy of the current boot record, assign the current boot record an alternate name, move the current boot record to an alternate location, and so on. Processes generated by another process can be called child processes, while processes which generate additional processes can be called parent processes. The relationship between child and parent processes can be called a process lineage. Child processes can generate processes as well. For example, a child process to copy a client boot record to a different location can generate a process to rename the copy of the boot record after the copy process has successfully completed. Each child process can be linked to the process that generated it as part of the process lineage created by the supervisor process.

The I/O filter driver can intercept any process (child, parent, etc.) as it attempts to access the current boot record. This information can be passed to the supervisor process. The supervisor process can compute the process lineage, if one exists, for the process. The process lineage can be used to determine if the process is legitimate. Embodiments include seeking the one or more parent processes 250 within the one or more exclusion lists, wherein the seeking is based on the supervisor process. The supervisor process can traverse the lineage tree to look for a parent process that is included in the one or more exclusion lists, hardcoded, etc. If a parent process is not found in the process lineage, the agent can be notified. In some examples, the agent can notify the user, system administrator, etc. that an attempt was made by malicious code to update one or more boot records and/or replace the boot records that were updated with the saved boot records prior to shut down. Other embodiments include nullifying, by the agent, the restoring 260. If the parent process is found in the process lineage, the boot record update was generated from a trusted process. Thus, the agent should allow the updated record to remain through the shutdown process and not overwrite it with the boot records that were saved. In this case, the agent can nullify the overwriting, ensuring the updated boot records are available when the device restarts.

As described above, a trusted process (or a child of a trusted process) can update the boot records at any time after startup. It is possible that a process, such as an OS update which can update one or more boot records, can run when a locker is also present on the system. In this case, it is possible that both a trusted process and a malicious process updated the boot record. Since the trusted process updated the record, the restoring would be overridden, resulting in a lock being left in the boot file and the user being locked out during the next restart. One or more additional comparisons can be performed by the agent prior to allowing the update by the child of the trusted process. In embodiments, the nullifying includes contrasting 262 the one or more client boot records with the one or more client boot records that were saved. If the contrasting results in a mismatch between an active boot record and a boot record that was saved, the child of the trusted process can be paused, halted, etc., and the original boot records can be restored. The child of the trusted process can then be unpaused, restarted, etc. The boot records that were updated by the child process can then be saved in the hidden location. Before shutdown, the updated boot records can be compared to the active boot records to ensure that no malicious updates, such as an update due to a locker, have occurred.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

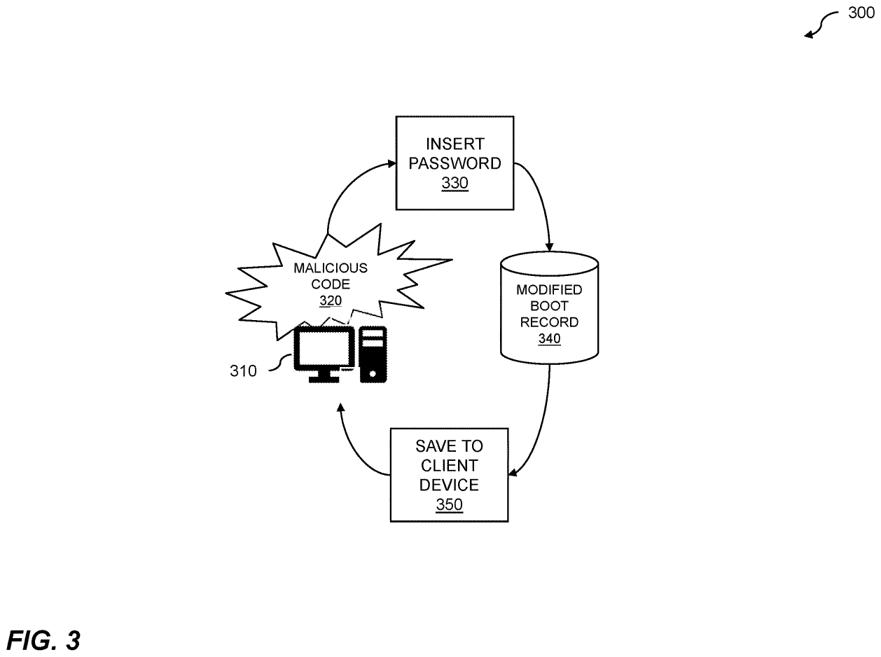

FIG. 3 is an infographic for a locker attack. The infographic 300 includes a user with a client device 310. The client device can be a personal computer, laptop, desktop, pad, tablet, workstation, smartphone, and so on. The client device can be running an operating system including Microsoft Windows®, macOS®, Linux®, Android®, iOS®, Chrome OS®, and so on. The client device can include one or more client boot records. In embodiments, the one or more client boot records include a master boot record (MBR). An MBR can be contained in the first sector of a hard drive or removable drive. It can function as the instruction manual for a client device, telling the system how the drive is organized and where to find the operating system. It can contain a bootloader program, which starts the loading of the operating system, and a partition table, which is a map of the drive to show how it is divided into sections or partitions. In embodiments, the one or more client boot records include a volume boot record (VBR). A VBR can reside on the first sector of a hard drive or solid state drive (SSD) partition. A hard drive or SSD can be divided into multiple partitions, each with its own VBR. The VBR can also contain a bootloader program and information about the file system used within the partition. The VBR can be used to continue the sequence of starting an operating system, after the MBR has identified which drive partition to boot from. In embodiments, the one or more client boot records include a GUID partition table. Modern compute devices can include a globally unique identifier (GUID) to identify drive partitions and types. Each GUID can function as a unique serial number, ensuring that each drive partition has a distinct ID. A GUID partition table (GPT) can contain a layout of the one or more partitions on a storage device, such as a hard drive or SSD. The GPT can be used on larger drives than the older MBR, can manage more partitions per drive, and can include additional security features.

The infographic 300 includes a request by a process on the client device to access the one or more client boot records. The process can comprise malicious code 320. The malicious code can be adware or ransomware; a trojan, rootkit, locker, or virus; and so on. The infographic 300 includes a locker attack. A locker attack's purpose is to lock a user out of the client device. A ransom can then be demanded for access to the device. Alternatively, the locker can simply cause resources to be spent to recover data on the drive. A password or PIN can be inserted 330 or changed so that the user cannot access critical system functions without the password. In the infographic 300, the malicious code inserts the password into a boot record. Once the boot record has been modified 340 by the malicious code, the boot record can be saved to the client device 350. Thus, the user will be required to type in the correct password in order to access the applications and files stored on the device on the next reboot. The malicious code can transmit the password to bad actors via an internet connection using a text message or email. The bad actor can then transmit a ransom message to the user, requiring the user to pay a ransom via electronic funds, cryptocurrency, etc. in order to receive the password and regain access to the device. In some instances, the malicious code can delete or rename one or more boot record files, copy the boot records to alternate locations, and so on. These actions can make the client device unable to be booted, requiring intervention by a system administrator and, in some cases, reinstallation of the operating system. These actions can cause significant losses of time, productivity, and data.

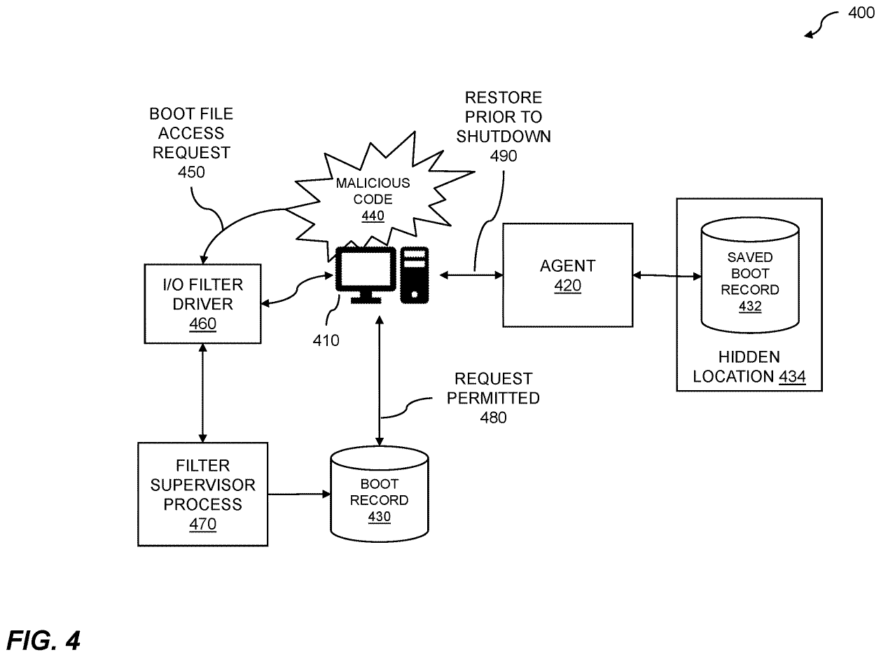

FIG. 4 is an infographic for locker protection with hidden boot files. A client device 410 is shown in infographic 400. The client device can comprise a personal computer, laptop, desktop, pad, tablet, workstation, smartphone, and so on. The client device can be running an operating system including Microsoft Windows®, macOS®, Linux®, Android®, iOS®, Chrome OS®, and so on. An agent 420 can run on the client device. The agent can be a computer program which acts autonomously on behalf of a user or another program. It can perform tasks, make decisions, and interact with other agents or systems to achieve specific goals. The client device can include one or more client boot records 430. In embodiments, the one or more client boot records include a master boot record (MBR). An MBR can be contained in the first sector of a hard drive or removable drive. It can function as the instruction manual for a client device, telling the system how the drive is organized and where to find the operating system. In embodiments, the one or more client boot records include a volume boot record (VBR). A hard drive or SSD can be divided into multiple partitions, each with its own VBR. The VBR can be used to continue the sequence of starting an operating system, after the MBR has identified which drive partition to boot from. In embodiments, the one or more client boot records include a GUID partition table. A GUID partition table (GPT) can contain a layout of the one or more partitions on a storage device, such as a hard drive or SSD.

Embodiments include saving, by an agent running on a client device, one or more client boot records 432 associated with the client device, wherein the saving is based on a hidden location 434. The saving can occur during or after a boot sequence, such that a known good copy of the boot records can be saved. The agent can identify a hidden storage location on one or more drive partitions included in the storage device. The hidden storage location can be a single area in one partition of a storage device, can be divided across one or more sections of a storage device partition, etc. The hidden storage location can be on a server such as a cloud server, a USB drive, and so on. The one or more hidden storage locations can be reserved by the software agent so that data written to or read by other processes do not include the hidden storage location drive sections. The agent can record one or more copies of the client boot records to the hidden storage location. The one or more copies of the client boot records can include date and time stamps, file size, a hash, as well as other file information for identification.

Malicious code 440 can infect the client device. The malicious code can comprise a locker which can attempt to lock a user out of the client device via an unauthorized update of one or more boot records. If successful, the user can be locked out of the client device until the password is obtained, or attempts are made to recover data on the hard drive. To prevent this scenario, embodiments include capturing, by an I/O filter driver 460, a request by a process 450 on the client device to access the one or more client boot records. The I/O filter driver can be a software component that intercepts input and output operations between a program, device driver, etc. and the operating system. It can function as a go-between, allowing for additional operations, filtering, or redirecting of data before it reaches its destination. The I/O filter driver can intercept requests to perform file operations on the active client boot records, such as reading, copying, deleting, and so on. The I/O filter driver can identify requests to access the active client boot records as they are generated by legitimate and/or malicious processes, and can further identify the application or process which generated the request. In the infographic 400, the malicious code generates the request to access the one or more client boot records. As described above and throughout, an I/O filter driver 460 can intercept the request and pass information to a supervisor process 470. In some implementations, the supervisor process can use the information passed (such as process name, timestamp, etc.) to check within one or more exclusion lists to determine if the request should be permitted. In other implementations, rather than interrupting file operations being performed on the one or more client boot records, the changes made by any process to the client boot records can be permitted. An example of allowing access made by any process is depicted in infographic 400. The request is permitted 480, even when sourced from a malicious code process that is not within one or more exclusion lists, hardcoded, within a lineage of a trusted process, etc. The access to the one or more client boot records can be permitted for legitimate code processes as well.

The names and file details, as well as the operations performed by legitimate and malicious code processes, can be recorded and stored by the filter supervisor process and can be used to analyze and classify future process changes to client boot records. Details of the code processes that updated one or more boot records can be transmitted to a supervisor process running on additional client devices included in the same network as the client device. Process and/or code details can be transmitted to system administration and security systems within the same network, as well as to cloud-based security and monitoring systems. These details can include information on malicious processes as well as trusted processes that update any boot record on any client device in the network.

Embodiments include comparing, during a shutdown operation on the client device, the one or more client boot records 430 with the one or more client boot records 432 that were saved. The comparing can be accomplished by an operating system command such as the diff command in Linux or the fc command in Windows. The comparing can be accomplished by a hex editor like Bless in Linux or HxD in Windows. The comparing can be accomplished by a disk imaging, backup, or recovery software application. The comparing can include file hash information which can be a fixed-size string of alphanumeric characters applied to the contents of a file, such as a client boot record. The string can be unique to the specific file. Even a tiny change in the file, such as a single character in one word or command, will result in a completely different file hash string. The amount of changes made to a file does not correspond to the changes in the associated file hash. The comparing can include filenames, timestamps, file sizes, and so on.

Embodiments include restoring, by the agent, prior to the conclusion of the shutdown operation 490, the one or more client boot records that were saved, wherein the restoring is based on the comparing. It can be assumed that the updating of the boot records was accomplished by a malicious process (see below for when a boot record is updated by a trusted process). Thus, the boot record can be replaced by the boot record that was saved in the hidden location by the agent. This can prevent a password from being inserted into the boot record, locking the user out of the device on the next restart. The restoring can be completed when the one or more active client boot records do not match the one or more copies of the client boot records saved in the hidden storage areas by the agent. Even a small change in the client boot record can result in the restoring of the client boot record from the saved copy in the hidden location. The restoring by the agent can be accomplished by an operating system copy command such as cp or scp in Linux, copy or xcopy in Windows, and so on. The restoring can be accomplished by a boot record utility such as bootrec. exe in Windows, grub or LILO in Linux, and so on. The agent can communicate third-party software to accomplish the restoring.

Further embodiments include reporting, by the agent 420, the restoring to a user of the client device. The reporting can be accomplished with a text message, email, alert, etc. As mentioned above, the agent can include a dashboard graphics user interface (GUI). A dashboard GUI can be a visual interface on a client device that displays key metrics, data graphics, and other relevant information in a clear and easily understood way. The agent can start the GUI to notify the user about changes in the one or more client boot records before restoring the boot records. The agent can start the GUI to notify the user after the client boot records have been restored from the hidden location. The GUI can allow the user to display additional details related to an alert, including details on the process that changed the one or more client boot records, the date and time of the client boot record changes, and so on. The GUI can allow the user to make choices about whether to allow the restoring of the client boot records to continue working or rather to stop the restoring process.

Other embodiments include communicating, by the agent, the restoring to a system administrator. The agent can include access to text messaging, email, voice communications, and network-based software applications. The agent can use one or more methods to notify a system administrator about changes in the one or more client boot records before restoring the boot records. The agent can notify the system administrator after the client boot records have been restored from the hidden location. The agent can allow the system administrator to display additional details related to an alert, including the client device identification, location, logged in user, details on the process that changed the one or more client boot records, date and time of the client boot record changes, and so on. The agent can allow the system administrator to make choices about whether to allow the restoring of the client boot records to continue working or rather to stop the restoring process. Similar to above, a GUI can be used by the system administrator to view results of any access, copying, restoring, etc. of boot records across one or more devices in a network.

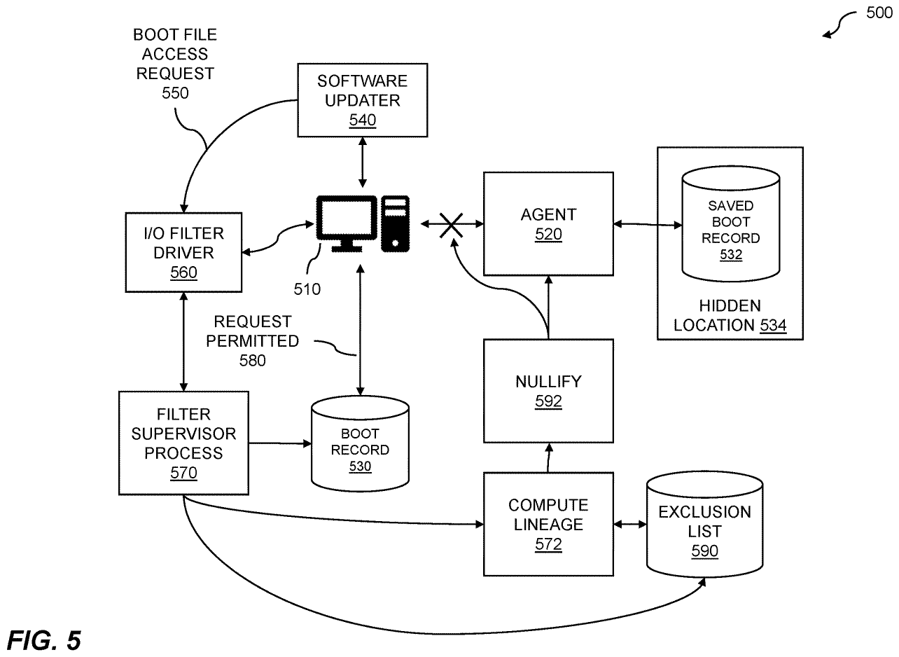

FIG. 5 is an infographic for nullifying boot record replacement with lineage detection. The infographic 500 includes a client device 510. The client device can be a personal computer, laptop, desktop, pad, tablet, workstation, smartphone, and so on. The client device can be running an operating system including Microsoft Windows®, macOS®, Linux®, Android®, iOS®, Chrome OS®, and so on. The infographic 500 includes an agent 520. The agent can be a computer program which acts autonomously on behalf of a user or another program. It can perform tasks, make decisions, and interact with other agents or systems to achieve specific goals.

Embodiments include saving, by an agent running on a client device, one or more client boot records 530 associated with the client device, wherein the saving is based on a hidden location 534. Thus, the saved boot records 532 can be hidden from any non-trusted processes. A trusted process, such as a software updater 540, can be running on the client device. The trusted process can make a request to access one or more boot files 550 within the client device. Embodiments include capturing, by an I/O filter driver 560, a request by a process on the client device to access the one or more client boot records. The I/O filter driver can be a software component that intercepts input and output operations between a program, device driver, etc. and the operating system. It can function as a go-between, allowing for additional operations, filtering, or redirecting of data before it reaches its destination. The I/O filter driver can intercept requests to perform file operations on the active client boot records, such as reading, copying, deleting, and so on. The I/O filter driver can identify access requests generated by legitimate or malicious processes, and can further identify the application or process which generated the request.

Embodiments include looking for the process within one or more exclusion lists 590, wherein the looking is based on a filter supervisor process 570 running in user space on the client device. The filter supervisor process can receive process request information from one or more I/O drivers included in the client device. As requests to access and/or operate on one or more client boot records are detected by the I/O filter driver, the process generating the request can be identified. The filter supervisor process can compare the details of a process generating the request to access the client boot records to the list of processes included in the exclusion lists. The process data can be used as look criteria against lists of processes included in the one or more exclusion lists. The exclusion lists can include legitimate processes such as operating system processes, known application processes, network and communications processes, backup processes, virus scan and other malware protection processes, and so on which are included on the client device. The exclusion lists can include file dates, file sizes, hashes, and other information related to legitimate drivers, programs, and processes that can originate file and/or directory requests. When the process is found within an exclusion list, a hardcoded name, etc., the request to update the boot record can be permitted 580. In some examples, the request can be permitted whether or not the process which initiated the request was found in an exclusion list, hardcoded list, etc. In that case, the agent can replace the boot record that was updated by a process not in the exclusion list, hardcoded names, etc.

Some embodiments include computing, by the supervisor process, a process lineage, wherein the computing includes one or more parent processes. Some processes can generate additional processes to complete program tasks. For example, a process to upgrade a client boot record can include processes to make a backup copy of the current boot record, assign the current boot record an alternate name, move the current boot record to an alternate location, and so on. Processes generated by another process can be called child processes, while processes which generate additional processes can be called parent processes. The relationship between child and parent processes can be called a process lineage. Child processes can generate processes as well. For example, a child process to copy a client boot record to a different location can generate a process to rename the copy of the boot record after the copy process has successfully completed. Each child process can be linked to the process that generated it as part of the process lineage created by the supervisor process. When a trusted process launches a child process, the child process can be trusted. Thus, when a process requests access to a boot record, the process lineage can also be checked to determine if a parent process is found within the exclusion list, hardcoded list, etc. If so, then the update made to the boot record can be considered safe. In this way, the process lineage can be computed, shown as compute lineage 572.

The I/O filter driver can intercept any process (child, parent, etc.) as it attempts to access the current boot record. This information can be passed to the supervisor process. The supervisor process can compute the process lineage, if one exists, for the process. The process lineage can be used to determine if the process is legitimate. Embodiments include seeking the one or more parent processes within the one or more exclusion lists, wherein the seeking is based on the supervisor process. The supervisor process can traverse the lineage tree to look for a parent process that is included in the one or more exclusion lists.

If a process, or a parent of the process that requested access to the boot record, is not found within any exclusion list, the process can be shut down, the agent can be notified, or no action can be taken. When a shutdown occurs, the boot records can be compared by the agent. Thus, embodiments include comparing, during a shutdown operation on the client device, the one or more client boot records with the one or more client boot records that were saved. If a difference is found, then the agent can restore the original boot record that was saved. Thus, embodiments include restoring, by the agent, prior to the conclusion of the shutdown operation, the one or more client boot records that were saved, wherein the restoring is based on the comparing.

If the process, or a parent of the process that requested access to the boot record, is found within any exclusion list, the agent can be notified that the access was due to a trusted process. Embodiments include nullifying 592, by the agent, the restoring. Even though the active client boot record is different than the copy of the client boot record stored in the hidden location, the agent can stop the restoring process that would have occurred during shutdown since the boot record was updated by a trusted process. As a result, the updated client boot record 530 can be used for subsequent boot sequences of the client device. A copy of the updated boot records can be saved to the hidden location as part of the next startup boot sequence. In some instances, the agent can notify the user and/or system administrator that the process has performed a change on the active client boot record.

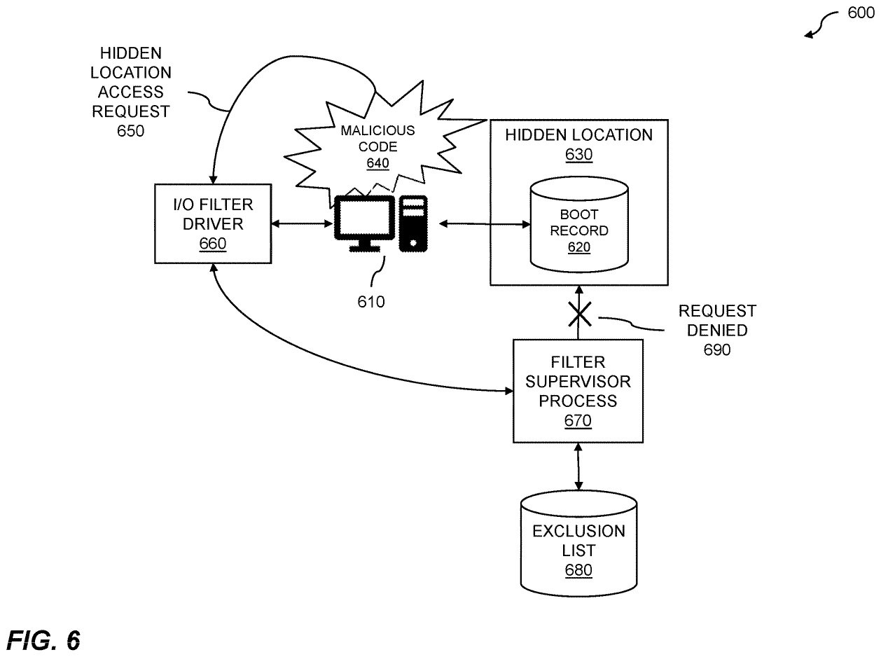

FIG. 6 is an infographic for locker protection with hidden boot records. The infographic 600 includes a client device 610. The client device can be a personal computer, laptop, desktop, pad, tablet, workstation, smartphone, and so on. The client device can be running an operating system including Microsoft Windows®, macOS®, Linux®, Android®, iOS®, Chrome OS®, and so on. Embodiments include saving, by an agent running on a client device, one or more client boot records 620 associated with the client device, wherein the saving is based on a hidden location 630. The agent can be a computer program which acts autonomously on behalf of a user or another program. It can perform tasks, make decisions, and interact with other agents or systems to achieve specific goals. The agent can identify a hidden storage location on one or more drive partitions included in the storage device. The hidden location can be reserved by the software agent so that data written to or read by other processes does not include the hidden storage location drive sections. The agent can record one or more copies of the client boot records to the hidden storage location. The one or more copies of the client boot records can include date and time stamps for identification.

The infographic 600 includes intercepting, by an I/O filter driver 660, a request 650 by a process on the client device to access the hidden location. The request can be generated by a malicious process 640. The I/O filter driver can be a software component that intercepts input and output operations between a program, device driver, etc. and the operating system. The I/O filter driver can identify requests to access the hidden location which includes the client boot record. The I/O filter driver can pass information including process name, timestamp, etc. to identify the application or process which generated the request. The process requests can include broad searches for boot record files across an entire drive partition, searches for reserved drive sectors, files designated as system files, and so on. The process requests can be file operations to be executed on specific file names in targeted locations, such as copy, rename, or delete commands. The file operations can include requests to access the hidden location used to save boot record copies. These file operations can include enumeration requests. An enumeration request can be a command to generate a list of files, folders, etc. stored in a file system of a compute device. Some malware code can be designed to search for boot record filenames in hidden directories and locations used by anti-malware programs. The I/O filter driver can capture requests to access files or directories stored in the hidden location and can pass the requests to the filter supervisor process for analysis.

The infographic 600 includes searching for the process within one or more exclusion lists 680, wherein the searching is based on a supervisor process 670 running in user space on the client device. As requests to access and/or operate on files in the hidden location are detected by the file I/O filter driver, the process generating the request can be identified. The process name can be used as a search criterion against a list of programs and processes included in the one or more exclusion lists. The exclusion lists can be made up of legitimate processes such as operating system processes, known application processes, network and communications processes, backup processes, virus scan and other malware protection processes, and so on which are included on the client device. The exclusion lists can include file dates, file sizes, hashes, and other information related to legitimate drivers, programs, and processes that can originate file and/or directory requests. The supervisor process running in user memory can compare the details of a process generating the request to access the hidden location to the list of processes included in the exclusion lists. The searching can be based on the intercepting. In embodiments, the one or more exclusion lists comprise one or more hardcoded process names. Process names from hardware and firmware vendors, operating systems, software distribution platforms, and so on can be added to the exclusion lists by a system administrator or by the filter supervisor process as users and administrators review processes and make changes through the agent GUI. In some instances, known malicious process information can be added to one or more lists available to the filter supervisor process to allow request analysis to be completed more quickly.

The infographic 600 includes denying the request 690, wherein the process was not found within the one or more exclusion lists. In instances where a process is not recorded in the one or more exclusion lists, the agent can deny the process request in the operations queue and notify the user and/or system administrator. The agent can include a dashboard graphics user interface (GUI). The agent can start the GUI to notify the user and/or system administrator about attempts to access the hidden location. The GUI can allow the user to display additional details related to an access attempt, including the process making the attempt, the date and time of the access attempt, parent or child processes related to the process that was denied, and so on. The GUI can allow the system administrator to make choices about whether to allow access to the hidden location in the event that a legitimate process was not entered into the exclusion lists.

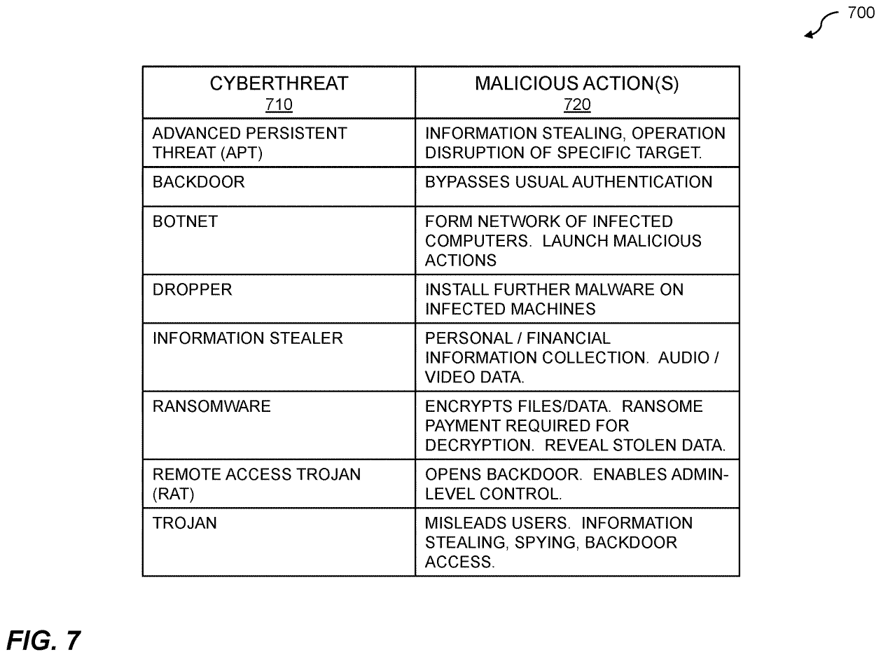

FIG. 7 is a table showing common cyberthreats. Detecting, tracking, blocking, and removing cyberthreats is critically important as today's IT stakeholders are constantly at risk of losing their valuable data, access to their computers, and even damage to IT infrastructure. Further, handling and responding to the cyberthreats has become extremely expensive. As the tools for managing the cyberthreats become more sophisticated, so do the root kits, password crackers, and similar tools used by bad actors. Clearly, the high tech games of cybertool cat and cyberthreat mouse have become exceptionally complicated.

Threats to computing systems and infrastructure, or cyberthreats, have become extremely common. The cyberthreats can include threats such as exploitation of bugs, flaws, and weaknesses in computing software and computing systems. The weaknesses can be based on flawed code that has not yet been updated, patched, or replaced. The weaknesses can further be based on hardware bugs, old hardware, and so on. The weaknesses in software and hardware can be exploited for a variety of criminal purposes including theft, extortion, physical damage, terrorism, and many others. The cyberthreats are often distributed using carefully crafted social engineering techniques. Social engineering techniques can be based on psychological manipulation, where the victim acts before considering dire consequences that might result from doing so. In a usage example, a user receives email purportedly from a close friend or relative who is in desperate need of cash to get out of a difficult situation. By clicking on an enclosed link, or by downloading an attachment, the user unwittingly installs malware that can execute tasks ranging from stealing personal data to compromising data by encrypting the data and demanding a ransom to obtain a key to decrypt the compromised data.

The table 700 shows a chart of some common cyberthreats. These common cyberthreats can be routinely observed to attempt evasion of security software such as antivirus software, network traffic monitors, domain name system request observation, etc. The table shows a list of cyberthreats 710 and a sample of malicious actions 720 that can be taken by the various cyberthreats. A cyberthreat can include an advanced persistent threat (APT). An APT can include a cyberthreat that can obtain unauthorized access to a network of computers, where the malware associated with the APT can remain undetected for an amount of time such as days, weeks, months, or years. During the time the APT is undetected, the malware associated with the APT can observe operations performed by the network of computers; steal data such as personal, financial, or classified data; or cause system disruptions. In a usage example, an APT can be used to shut down a national or regional power grid, disrupt the flow of fuel such as natural gas, or cause false toxin warnings for a water distribution system. APTs can be conducted by state-sponsored actors, cyberterrorists, and other large, well-organized groups.

A cyberthreat can include a backdoor threat. A back door can provide access to a computing system by bypassing access authentication protocols or encryption. The back door can be accessed using a security flaw in the system hardware or software. The back door can be opened and exploited by malware downloaded onto one or more computers. A cyberthreat can include a botnet. A botnet can be formed from a set of computers or other internet-connected devices that are executing one or more bots. A bot is an automated software application that executes on infected computers and internet-connected devices. The software can execute scripts that can appear to be human activity. The imitated human activity can include sending email messages (e.g., spam), sending text messages, and the like. The computer systems that make up the botnet can execute their scripts to launch cyberattacks on a website, organization, etc. Such attacks can include distributed denial-of-service (DDoS) attacks in which the targeted systems are overwhelmed by requests from the computer systems associated with the botnet.

The cyberthreat can include a dropper. A dropper is a form of Trojan horse (discussed below) malware that is used to install further malware on computer systems that were infected by the Trojan horse malware. The additional malware installed by the dropper malware can open back doors into the infected computer systems, download and execute viruses, and so on. The malware installed by the dropper malware can be configured to elude antivirus software. Some malware can damage virus detection capabilities of the antivirus software. The cyberthreat can include an information stealer. An information stealer, or “infostealer,” is software designed for malicious purposes such as breaching computing system security with the intent of stealing data stored on the computer systems. The infostealer can further obtain information such as login credentials, keystrokes, and so on. The stolen information is sent by the infostealer to a command-and-control system operated by an attacker. The stolen information is typically aggregated, bundled, and sold to organizations that intend to use the stolen information for malicious purposes.

The cyberthreat can include ransomware. Ransomware includes code that disables a user's access to their data by encrypting the data. The user loses access to their data unless a ransom is paid to the attacker. The attacker then provides a key to the user, with which the user can decrypt their data. The ransom is typically paid using a digital currency thereby making tracing of ransom payments difficult. Also, some attackers collect the ransom without sending the decryption key, thus causing complete loss of the user's data. The user is left to recreate their data or to attempt to recover it from one or more backups of their data. The user is forced to recreate or somehow recover their data because the decryption of their encrypted data is considered an intractable problem primarily because of the time and computational resources required for decryption without the key.

The cyberthreat can include a remote access trojan (RAT). A remote access trojan, which is sometimes referred to as “creepware,” can invade user privacy, spy on users, steal data, and so on. Stolen data is forwarded to the attacker. Stolen data can be collected and sold to other attackers for malicious purposes. The cyberthreat can include a Trojan horse. The Trojan horse or “Trojan,” much like the Trojan horse of Greek mythology, disguises itself as a standard, legitimate program, as an enclosure from a known or trusted source, as a legitimate weblink or download page, and so on. The trojan dupes a user into downloading the trojan malware. The user is typically duped based on a social engineering ploy used to deliver the trojan. Once installed, the trojan can perform a variety of malicious actions such as opening a back door to the system infected with the trojan. The trojan can contact a computer system such as a command-and-control system. The command-and-control system, which is located somewhere on a computer network, can gain access to the infected computer using the back door opened by the trojan. The computer network can include the Internet, a corporate or organizational network, and so on. Command-and-control system access to the infected computer can steal information from the infected computer, encrypt the information on the computer, etc.

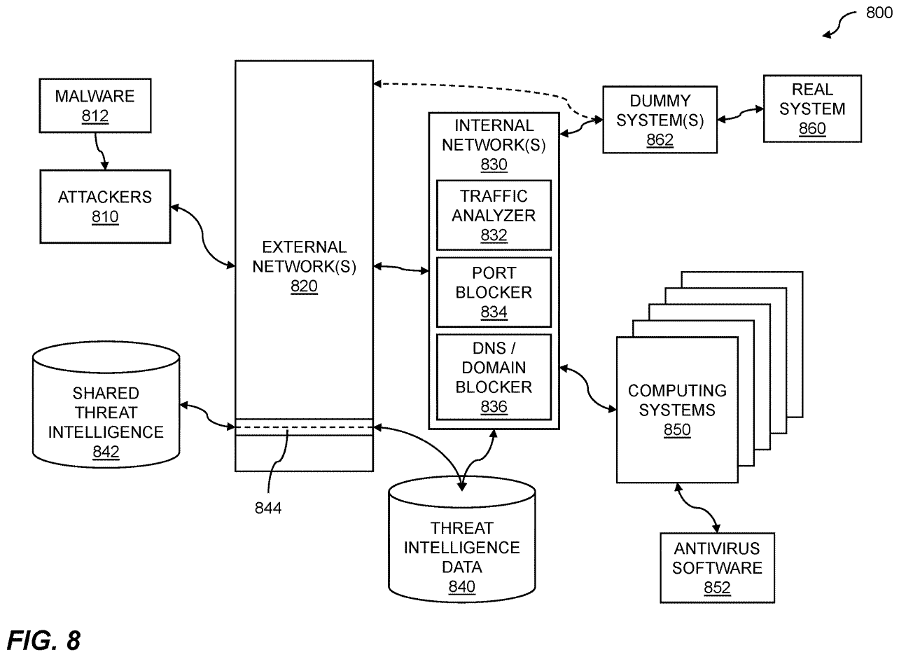

FIG. 8 is a diagram showing cyberthreat countermeasures. Discussed previously, cyberthreats are routinely launched at organizations of all types and sizes, at individual users generally, at specific individuals, and so on. A portion of the cyberattacks install malware that can be used to gain unauthorized access to one or more computer systems; to steal personal, confidential, and corporate secret data; to maliciously encrypt user information; and the like. Thus, detecting, analyzing, responding to, and removing the malware are all techniques that are extremely critical to the victims of the malware. In addition, cyberattacks can target specific computers and computing systems with a flood of data requests that can overwhelm the target computers and computing systems. Mitigating such attacks is a critical priority for organizational IT departments and individual users alike.

Organizations can actively search for cyberthreats or can enlist the services of organizations that do. Individuals can monitor for cyberthreats using protection software such as antivirus software. The individuals can keep current with new cyberthreats by regularly checking for and installing software updates. Searching for cyberthreats, or cyberthreat “hunting,” is an activity that regularly searches for cyberthreats and determines remedies and responses to those discovered threats. While cyberthreat hunting was traditionally conducted manually, based on careful analysis by trained analysts, tools for cyberthreat hunting are emerging that enable at least partial automation of the analysis. The automation of the threat analysis can be based on machine learning models. The tools can assist the analyst to identify threats and help determine how to counter them. The analyst can proceed to track identified and potential threats, monitor threats as the threats evolve, and so on. The data that is analyzed for threats can include network data collected from networking equipment, network monitoring software, etc.

Substantial amounts of data can be collected regarding cyberthreats. The collection of such cyberthreat data, or cyberthreat intelligence, formalizes the collection of data, analysis of the data, and distribution of the data. The data is associated with current cyberthreats and potential cyberthreats. The data can include information regarding malefactors referred to as “threat actors,” the tactics used by these bad actors, and the hardware and software vulnerabilities that are exploited in the cyberattacks. The information enables enterprises and organizations to anticipate the types of cyberattacks that are likely or possible to occur; best responses to the cyberattacks; and prevention of attacks by amending, correcting, or patching vulnerabilities. The cyberthreat intelligence information can be collected from a variety of public and private sources. The public and private sources of cyberthreat intelligence can be based on open source intelligence sources, human intelligence (HUMINT), device log files, social media sources, technical intelligence, and so on. The sources can further include forensic sources such as data extracted from the dark web, monitored internet traffic, etc.

The diagram 800 shows example cyberthreat countermeasures. Attackers 810 can obtain malware 812. The malware can be created by the attackers, purchased from a hacking site, and so on. The attackers can launch their malware using infected email messages, fake download links on websites, and the like. Discussed previously, the infected email and the fake download links can be designed using social engineering techniques which dupe the unsuspecting user into downloading the malware to their computing systems. The infected email is sent over an external network 820 such as the Internet. The fake download site can also be accessible via the external network. The external network can be coupled to an internal network 830. The internal network can be associated with an organization such as a business, financial institution, social networking site, etc. In addition to the routers, switches, etc. that comprise the internal network, hardware and software tools can be used to monitor the network. The tools can include a traffic analyzer 832. The traffic analyzer can determine one or more types of traffic that are traversing the internal network. The traffic can include voice data traffic, video data traffic, data traffic (e.g., files), and so on. One or more data protocols can be associated with the data traffic, such as TCP, UDP, SSH, SFTP, and the like. The tools can include a port blocker 834. The port blocker such as a firewall can block specific network ports to all traffic, certain types of traffic, etc. The port blocker can close unused ports, thereby reducing the risk of a cyberthreat attacking the internal network via an otherwise unused port. The tools can further include a DNS/domain blocker 836. The DNS/domain blocker can block access to specific websites, entire domains, etc. In a usage example, network intelligence indicates that a preponderance of unwanted or spam email is originating from a domain such as “unwantedmail.com.” The domain blocker can block all traffic from the site temporarily or permanently.

The cyberthreat hardware and software tools can access threat intelligence data 840. The threat intelligence data can include network data collected from the Internet. The threat intelligence data can include amounts of traffic, types of traffic, ports accessed, etc. The threat intelligence data can be analyzed by trained analysts, partially or completely analyzed by software, etc. The threat intelligence data can further include shared threat intelligence data 842. The shared threat intelligence data can be obtained from open source intelligence sources, human intelligence sources, etc., and described above. The shared threat intelligence data can be accessed by a secure channel 844 such as a VPN. The internal network 830 can be coupled to one or more internal computing systems 850. The internal computing systems can include organizational servers, desktop computers, laptops administered by the organization, and so on. The computing systems can include devices such as organization-issued smartphones, personal smartphones and tablets, etc. The one or more computing systems can be installed with anti-cyberthreat software such as antivirus software 852.

Another technique that can be used to thwart cyberthreats can include “security through obscurity.” That is, a “real” computing system can be hidden behind one or more dummy systems. In the diagram 800, a real system 860 can be hidden behind one or more dummy systems 862. The real computing system can include a high security system, a restricted access system, and so on. A first dummy system can be located in plain sight. Further dummy systems, if present, can be located in secured locations such as locked data centers, offsite data centers, and the like. This misdirection created by the one or more dummy systems not only makes exploiting common vulnerabilities of computing systems increasingly difficult since N systems must be hacked before accessing the real system, but further obscures the physical location of the real system. Obscuring the physical location of the real system can reduce the risk of hacking by an employee since the knowledge of the physical location of the computing system is strictly limited to a select few employees. The real system can access the internal network or the external network through the series of dummy systems.

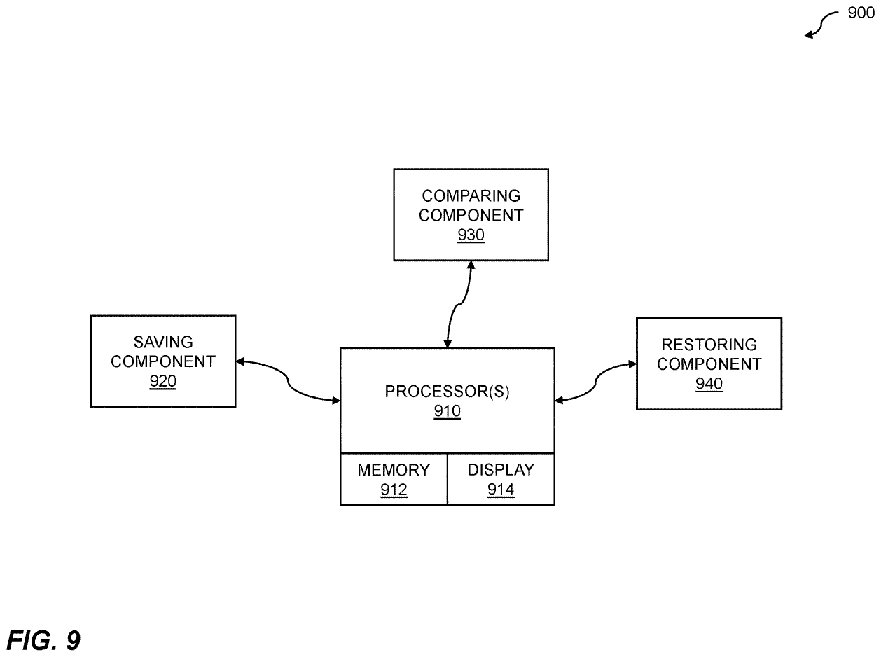

FIG. 9 is a system diagram for locker protection with hidden boot files. The system 900 can include one or more processors 910 coupled to a memory 912 which stores instructions. The system 900 can include a display 914 coupled to the one or more processors 910 for displaying data, prompts, file drivers, exclusion lists, boot records, intermediate steps, instructions, and so on. In embodiments, one or more processors 910 are coupled to the memory 912, wherein the one or more processors, when executing the instructions which are stored, are configured to: save, by an agent running on a client device, one or more client boot records associated with the client device, wherein the saving is based on a hidden location; compare, during a shutdown operation on the client device, the one or more client boot records with the one or more client boot records that were saved; and restore, by the agent, prior to conclusion of the shutdown operation, the one or more client boot records that were saved, wherein the restoring is based on the comparing.

The system 900 includes a saving component 920. The saving component 920 includes functions and instructions for saving, by an agent running on a client device, one or more client boot records associated with the client device, wherein the saving is based on a hidden location. The client device can be a personal computer, laptop, desktop, pad, tablet, workstation, smartphone, and so on. The client device can be running an operating system including Microsoft Windows®, macOS®, Linux®, Android®, iOS®, Chrome OS®, and so on. The agent can be a computer program which acts autonomously on behalf of a user or another program. It can perform tasks, make decisions, and interact with other agents or systems to achieve specific goals. In embodiments, the one or more client boot records include a master boot record (MBR). An MBR can be contained in the first sector of a hard drive or removable drive. It can function as the instruction manual for a client device, telling the system how the drive is organized and where to find the operating system. In embodiments, the one or more client boot records include a volume boot record (VBR). A VBR is similar to an MBR in that it can reside on the first sector of a hard drive or solid state drive (SSD) partition. The VBR can be used to continue the sequence of starting an operating system, after the MBR has identified which drive partition to boot from. In embodiments, the one or more client boot records include a GUID partition table. A GUID partition table (GPT) can contain a layout of the one or more partitions on a storage device, such as a hard drive or SSD. The agent can identify a hidden storage location on one or more drive partitions included in the storage device. The hidden storage location can be a single unused area in one partition of a storage device. The hidden storage location can be divided across one or more unused or empty sections of a storage device partition. The hidden storage location can be divided across one or more storage device partitions. The one or more hidden storage locations can be reserved by the software agent so that data written to or read by other processes do not include the hidden storage location drive sections. The agent can record one or more copies of the client boot records to the hidden storage location. The one or more copies of the client boot records can include date and time stamps for identification.

The system 900 includes a comparing component 930. The comparing component 930 includes functions and instructions for comparing, during a shutdown operation on the client device, the one or more client boot records with the one or more client boot records that were saved. The comparing can be accomplished by an operating system command such as the diff command in Linux or the fc command in Windows. The comparing can be accomplished by a hex editor like Bless in Linux or HxD in Windows. The comparing can be accomplished by a disk imaging, backup, or recovery software application. The comparing can include filenames, timestamps, file sizes, and so on. The comparing can include file hash information.

The system 900 includes a restoring component 940. The restoring component 940 includes functions and instructions for restoring, by the agent, prior to the conclusion of the shutdown operation, the one or more client boot records that were saved, wherein the restoring is based on the comparing. The restoring can be completed when the one or more active client boot records do not match the one or more copies of the client boot records saved in the hidden storage areas by the agent. The restoring can include deleting the current boot records and replacing them with copies of the boot record stored in the hidden storage area. The restoring can be accomplished by an operating system copy command such as cp or scp in Linux, copy or xcopy in Windows, and so on. The restoring can be accomplished by a boot record utility such as bootrec. exe in Windows, grub or LILO in Linux, and so on. The restoring can be accomplished by a third-party software application.

The system 900 can include a computer program product embodied in a non-transitory computer readable medium for data analysis, the computer program product comprising code which causes one or more processors to perform operations of: saving, by an agent running on a client device, one or more client boot records associated with the client device, wherein the saving is based on a hidden location; comparing, during a shutdown operation on the client device, the one or more client boot records with the one or more client boot records that were saved; and restoring, by the agent, prior to conclusion of the shutdown operation, the one or more client boot records that were saved, wherein the restoring is based on the comparing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data analysis comprising:
saving, by an agent running on a client device, one or more client boot records associated with the client device, wherein the saving is based on a hidden location;
comparing, during a shutdown operation on the client device, the one or more client boot records with the one or more client boot records that were saved; and
restoring, by the agent, prior to conclusion of the shutdown operation, the one or more client boot records that were saved, wherein the restoring is based on the comparing.

2. The method of claim 1 further comprising intercepting, by an I/O filter driver, a request by a process on the client device to access the hidden location.

3. The method of claim 2 further comprising searching for the process within one or more exclusion lists, wherein the searching is based on a supervisor process running in user space on the client device.

4. The method of claim 3 wherein the one or more exclusion lists comprise one or more hardcoded process names.

5. The method of claim 3 further comprising allowing the request, wherein the process was found within the one or more exclusion lists.

6. The method of claim 5 further comprising updating, by the process, the one or more client boot records that were saved.

7. The method of claim 3 further comprising denying the request, wherein the process was not found within the one or more exclusion lists.

8. The method of claim 1 further comprising capturing, by an I/O filter driver, a request by a process on the client device to access the one or more client boot records.

9. The method of claim 8 further comprising looking for the process within one or more exclusion lists, wherein the looking is based on a supervisor process running in user space on the client device.

10. The method of claim 9 further comprising overriding the restoring, wherein the process was found within the one or more exclusion lists.

11. The method of claim 10 wherein the overriding includes further comparing the one or more client boot records with the one or more client boot records that were saved.

12. The method of claim 9 further comprising computing, by the supervisor process, a process lineage, wherein the computing includes one or more parent processes.

13. The method of claim 12 further comprising seeking the one or more parent processes within the one or more exclusion lists, wherein the seeking is based on the supervisor process.

14. The method of claim 13 further comprising nullifying, by the agent, the restoring.

15. The method of claim 14 wherein the nullifying includes contrasting the one or more client boot records with the one or more client boot records that were saved.

16. The method of claim 1 further comprising reporting, by the agent, the restoring to a user of the client device.

17. The method of claim 1 further comprising communicating, by the agent, the restoring to a system administrator.

18. The method of claim 1 wherein the one or more client boot records include a master boot record (MBR).

19. The method of claim 1 wherein the one or more client boot records include a volume boot record (VBR).

20. The method of claim 1 wherein the one or more client boot records include a GUID partition table.

21. A computer program product embodied in a non-transitory computer readable medium for data analysis, the computer program product comprising code which causes one or more processors to perform operations of:
saving, by an agent running on a client device, one or more client boot records associated with the client device, wherein the saving is based on a hidden location;
comparing, during a shutdown operation on the client device, the one or more client boot records with the one or more client boot records that were saved; and
restoring, by the agent, prior to conclusion of the shutdown operation, the one or more client boot records that were saved, wherein the restoring is based on the comparing.

22. A computer system for data analysis comprising:
a memory which stores instructions;
one or more processors coupled to the memory, wherein the one or more processors, when executing the instructions which are stored, are configured to:
save, by an agent running on a client device, one or more client boot records associated with the client device, wherein the saving is based on a hidden location;
compare, during a shutdown operation on the client device, the one or more client boot records with the one or more client boot records that were saved; and
restore, by the agent, prior to conclusion of the shutdown operation, the one or more client boot records that were saved, wherein the restoring is based on the comparing.
